(19) United States
(12) Patent Application Publication
(10) Pub. No.: US 2014/0129579 A1
(43) Pub. Date: May 8, 2014

(54) MUTUAL MATCHING SYSTEM

(71) Applicants: TIMOTHY BRAMHALL, Cleveland Heights, OH (US); BRIAN ASQUITH, Cleveland, OH (US)

(72) Inventors: TIMOTHY BRAMHALL, Cleveland Heights, OH (US); BRIAN ASQUITH, Cleveland, OH (US)

(21) Appl. No.: 13/844,378

(22) Filed: Mar. 15, 2013

Related U.S. Application Data
(60) Provisional application No. 61/722,733, filed on Nov. 5, 2012.

(51) Int. Cl. G06F 17/30

(52) U.S. Cl. CPC G06F 17/30386
USPC 707/758

(57) ABSTRACT

The various technologies presented herein relate to identifying a mutual interest (“mutual match”) between individuals. An individual can indicate an interest regarding a second individual, however a notification of interest is not forwarded to the second individual unless the second individual has similarly indicated an interest regarding the first individual, i.e., a mutual match exists. Profiles for each of the individuals can be forwarded to a central system. An individual can request to view other individuals profiles based on such criteria as the location of the individual. The profiles of any other individuals in the vicinity of the individual can be compiled and forwarded to the individual for viewing. Viewing of profiles can be performed after the individual has vacated the location. Communication with the central system can be via a mobile computing device(s).

### RELATED APPLICATION

This application claims priority to U.S. Provisional Patent Application No. 61/722,733, filed on Nov. 5, 2012, entitled “MUTUAL MATCHING SYSTEM”, the entirety of which is incorporated herein by reference.

### TECHNICAL FIELD

The various exemplary embodiments relate generally to an approach to facilitate determining mutual interest between two or more individuals.

### BACKGROUND

Computers have become ubiquitous in the 21^{st} Century finding application in practically every aspect of the human world, even into the field of human relationships, whereby an individual can express an interest in another individual through a computer-based application (e.g., MATCH.COM, EHARMONY.COM, PLENTYOFFISH.COM, BLENDR.COM, and the like). Conventionally, a first individual can access an online dating application, submit a profile about themselves and subsequently view profiles of others who are seeking out friendship, a relationship, marriage, and the like. When an individual (e.g., a first individual) spots a profile of someone (e.g., a second individual) they might have an interest in, the first individual can indicate their interest in the second individual via the online dating application. The online dating application can subsequently forward a notification regarding the first individual's interest to the second individual. Upon receipt of the notification, the second individual can view the profile of the first individual and, if they are similarly interested, the second individual can indicate to the first individual the mutual interest, e.g., via a notification feature in the online dating application, via email, phone, webcam chat, etc. And as they say, the rest is history.

However, one drawback of such conventional online dating applications is that individuals can typically only view profiles of other subscribers via a desktop, mobile phone, etc., with no indication of where other subscribers may be at any given time. Typically, the only location information presented with regard to a subscriber is a generalized home location, e.g., city, state, country, etc. Hence, the online dating applications are limited in their amenability for meeting someone in a random public location such as a bar, restaurant, etc. However, there is a high probability that many people who are frequenting a public location such as a bar on a weekend may indeed be looking to meet someone to date. Hence, conventional online dating applications are limited when it comes to their applicability with regard to helping people meet each other while out and about.

### SUMMARY

Various technologies pertaining to determining a mutual interest between a first individual and a second individual, and subsequently notifying the first individual and the second individual of the mutual interest are described herein. In an exemplary, non-limiting embodiment that comprises a method for the determining and notifying is presented. The method comprising receiving a first profile relating to a first individual and further receiving a second profile relating to a second individual can be performed. Subsequently performing the receiving of a first notification associated with the first individual, wherein the first notification indicating the first individual having an interest in the second individual. A determination can be made whether a second notification already being received from the second individual, wherein the second notification indicating the second individual having an interest in the first individual, and in the event of determining the second notification being received, the first individual can be matched with the second individual.

In a further, exemplary, non-limiting embodiment, a system can include a profile component configured to receive a first indication of a first individual having an interest in a second profile associated with a second individual and to further receive a second indication of the second individual having an interest in a first profile associated with the first individual. The system can further include an interest component configured to determine the existence of the first indication and the second indication and, based on the determined existence, identify mutual interest between the first individual and the second individual. A match component can be further included in the system, wherein the match component can be configured to forward the first indication to the second individual and the second indication to the first individual.

A further exemplary, non-limiting embodiment comprises a computer readable storage medium comprising computer executable instructions that, in response to execution, cause a computing system including a processor to perform operations, the operations comprising receiving a first profile relating to a first individual, receiving a second profile relating to a second individual, and further, receiving a first notification associated with the first individual, wherein the first notification indicating the first individual having an interest in the second individual. The operations can further include determining whether a second notification already being received from the second individual, wherein the second notification indicating the second individual having an interest in the first individual, and in the event of determining the second notification being received, matching the first individual with the second individual.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a block diagram illustrating exemplary, non-limiting embodiments for generating and forwarding profiles to a mutual matching system.

FIG. 2 is a block diagram illustrating exemplary, non-limiting embodiments for viewing profile compilations with a mutual matching system.

FIG. 3 is a block diagram illustrating exemplary, non-limiting embodiments for indicating an interest in a profile presented with a mutual matching system.

FIG. 4 is a block diagram illustrating exemplary, non-limiting embodiments for indicating a mutual interest between individuals utilizing a mutual matching system.

FIG. 5 is a block diagram illustrating exemplary, non-limiting embodiments for indicating a mutual interest between individuals utilizing a mutual matching system.

FIG. 6 is a flow diagram illustrating an exemplary methodology for determining a mutual interest between individuals.

FIG. 7 is a flow diagram illustrating an exemplary methodology for determining a viewing period for a profile(s).

FIG. 8 is a flow diagram illustrating an exemplary methodology for configuring a search as part of a mutual match operation.

FIG. 9 is a flow diagram illustrating an exemplary methodology for removing an interest in an individual.

FIG. 10 is a flow diagram illustrating an exemplary methodology for directing two individuals to facilitate a meeting.

FIG. 11 illustrates an exemplary computing device.

### DESCRIPTION

The various, exemplary, non-limiting embodiments presented herein relate to matching an interest between individuals. As previously described, conventional systems utilize an approach of a first individual indicating an interest in a second individual, a notification of the first individual's interest is forwarded to the second individual, whereupon the second individual can be directed to view the first individual's profile. In a similar manner, the various embodiments presented herein relate to an individual expressing an interest in another individual. However, unlike conventional approaches, where the interest of a first individual regarding a second individual is forwarded from the first individual for review by the second individual, various embodiments herein relate to the interest of the first individual in the second individual is only made known if there is an interest in the first individual by the second individual, i.e., a mutual interest exists. The concept of a mutual interest is termed a ‘mutual match’ herein. In an exemplary scenario, a number of individuals may be partaking in a ‘singles’ meet-up whereby the individuals are at a location such as a bar. It is not uncommon that even at an event designed for single people to meet, there may still be a reluctance for a first individual to speak with a second individual, e.g., one of the individuals is shy, a situation didn't present itself for the individuals to actually speak to each other, etc. However, by utilizing a mutual matching system, even if individuals do not actually speak to each other, an interest in an individual can be indicated and if there is a mutual matching then the two individuals can be notified of their mutual interest either during the event or at a subsequent time, as described further herein.

The various, exemplary, non-limiting embodiments are now described with reference to the drawings, wherein like reference numerals are used to refer to like elements throughout.

In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

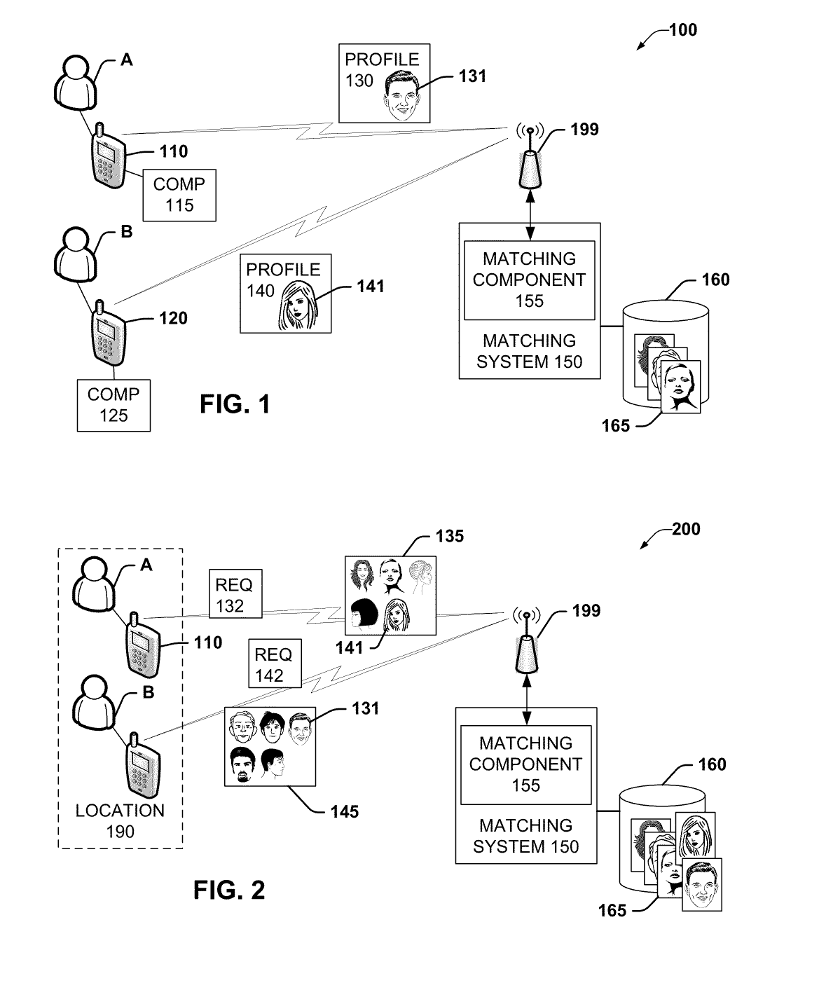

FIG. 1 illustrates a matching system 100 in accordance with an exemplary, non-limiting embodiment. As shown in FIG. 1, a first individual (individual A) can be operating a mobile device 110 which has a local matching component 115 operating thereon. A second individual (individual B) can be operating mobile device 120 which has a local matching component 125 operating thereon. Mobile devices 110 and 120 are communicatively coupled to matching system 150, where such communications can be by any suitable means such as wireless telephony, cellular telephony, satellite, via a local area network (LAN), via a wide area network (WAN), and the like. Mobile devices 110 and 120 can be any suitable device to facilitate conducting any of the various embodiments presented herein, where the device can be a mobile phone, a laptop computer, a tablet personal computer, a wearable computer, a body borne computer, a personal computer, or any other suitable means for entering and transmitting information.

Individual A, having previously subscribed to the matching operation (e.g., based on such ways as making a subscribing payment, downloading the application, setting up an account, etc.) generates a profile 130, where profile 130 can be configured to present information regarding individual A for review by other individuals (e.g., individual B) who are partaking in the matching application. Profile 130 can be configured by answering questions, entering information in datafields, making choices by selection of radio buttons, checkboxes, etc., via local matching component 115. In an embodiment, profile 130 can include a photoimage 131 of individual A to facilitate recognition of individual A by other individuals, as described further herein. Photoimage 131 can comprise of a digital image, a digital photograph, digital scan, and the like of individual A (and similarly photoimage 141 can comprise of a digital image, photograph, etc., of individual B). Upon generating a profile 130 (e.g., which may simply include photoimage 131), individual A indicates (e.g., by pressing a send button associated with local matching component 115, e.g., a button on a keypad of mobile device 110) they wish to publish their profile for other individuals to view, whereupon profile 130 can be transmitted from mobile device 110 to a matching system which can comprise a matching system 150 with matching component 155 operating thereon. Matching system 150 can be any suitable system such as a central server component comprising various components to effect operation of one or more embodiments presented herein. A data store 160 can be associated with matching system 150, where data store 160 can be configured to store profiles 165 comprising profiles of the various individuals who have subscribed to the matching operation. Accordingly, profile 130 and photoimage 131 can be stored in data store 160.

Similarly, as further shown in FIG. 1, individual B operating mobile device 120, with local matching component 125 operating thereon, can configure a profile 140. As stated previously, profile 140 can comprise a photoimage (e.g., photoimage 141) of individual B for viewing by other individuals subscribing to the matching operation (e.g., individual A). Upon completion of profile 140, individual B can select that profile 140 be forwarded to matching system 150, where profile 140 can be added to the profiles 165 stored in memory 160.

FIG. 2 illustrates a matching system 200 in accordance with an exemplary, non-limiting embodiment. FIG. 2 is a continuation of the various features presented in FIG. 1. As shown in FIG. 2, both individual A and individual B are at a location 190 (where location 190 can be determined by range of profile publishing, as further described herein). Location 190 can be any location where one or more individuals subscribing to the matching system may wish to known if other subscribing individuals are in the vicinity thereof, where, for example, location 190 can be a bar, a nightclub, a restaurant, a sports complex, an entertainment venue, a library, a park, a theatre, a street, a plaza, or any other venue/location.

The respective locations of individual A and individual B can be determined based on any suitable location provisioning application such as global position service (GPS) or similar means as known in the art, whereby such location provisioning application can be respectively operating on mobile devices 110 and 120. Upon reaching a location, e.g., individual A has arrived at the location 190, e.g., has entered a bar, individual A can place a request for other individuals partaking in the matching system be made known to individual A. The request can be sent by activation of a request button (e.g., comprising a keyboard interface on mobile phone 110) included in local matching component 115. Upon determining a request is being placed by individual A, local matching component 115 can forward a request 132 to matching system 150, where to facilitate determination of the location of individual A, request 132 can include GPS information regarding the location of individual A. Hence, the location of individual A can be known by matching system 150. In response to receiving request 132, matching system 150 can review profiles 165 to identify which individuals are in vicinity (e.g., a pre-defined distance) of individual A. Matching component 155 can generate a profile compilation 135 of one or more individuals profiles who are determined to be at, or in the vicinity of, location 190, and forward the profile compilation 135 to individual A for presentation on mobile device 110, e.g., via local matching component 115. It is to be appreciated that profile compilation 135 can be dynamically generated and updated by matching component 155 as necessary. For example, if a profile compilation 135 is generated at time x, but at a subsequent time x+y, matching component 155 determines that another individual subscribing to the matching system is now at location 190, an updated profile compilation 135 can be generated to include the newly arrived individual(s) for presentation on any receiving devices (e.g., mobile device 110).

In a similar manner to that described, individual B can also be located at location 190 (e.g., newly arrived or previously there, for example), and wants to know what other subscribing individuals are at location 190. A request can be instigated by individual B (e.g., via local matching component 125), whereupon a request 142 (including GPS information) can be transmitted to matching system 150 and matching component 155. In response to receiving request 142, matching component 155 generates a profile compilation 145 based on the location of individual B and forwards profile compilation 145 to mobile device 120 for presentation by application 125 to individual B. Profile compilation 145 can include profile 130 and photoimage 131 of individual A. Further, a profile compilation 135 can include (e.g., in an original generation or in an updated version based on subsequent arrival of individual B) profile 140 and photoimage 141 associated with individual B, for presentment to individual A via mobile device 110 and local matching component 115. Hence, based on both individuals A and B being at location 190, both individuals A and B have profile compilations (e.g., respective profile compilations 135 and 145) which include a photoimage (e.g., respective photoimages 131 and 141) of the other individual (e.g., individual A can view individual B's photoimage, and vice-versa).

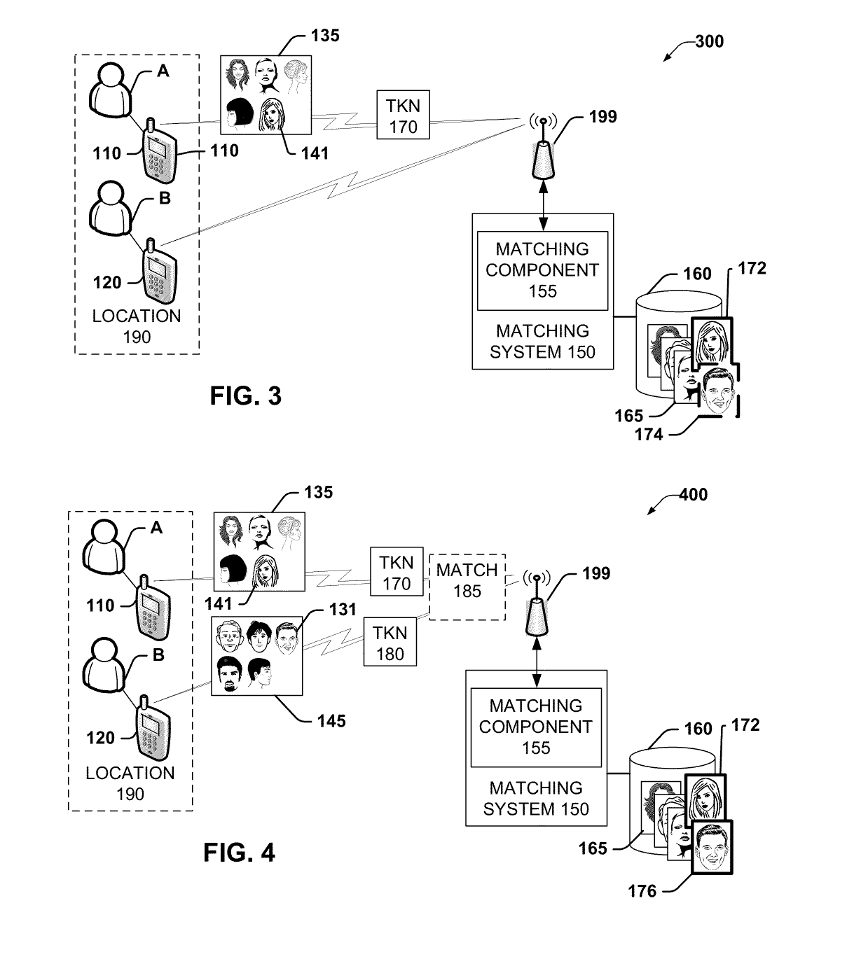

FIG. 3 illustrates a matching system 300 in accordance with an exemplary, non-limiting embodiment. FIG. 3 is a continuation of the various features presented in FIGS. 1 and 2. As illustrated in FIG. 3, individual A, via local matching component 115 on mobile device 110, can view profile compilation 135. Upon reviewing profile compilation 135 individual A finds the photoimage 141 and/or profile 140 to be of interest. The interest may be a result of individual A being interested in the photoimage 141, something that attracts their attention in profile 140, or, for example, spotting individual B at location 190 and determining that individual B is a subscriber of the matching system (e.g., profile 140 is included in profile compilation 135). Individual A can place an interest request to matching component 155, e.g., by selecting an ‘interest’ button associated with profile 140 and/or photoimage 141, whereupon local matching component 115 can generate an interest token 170 which can be transmitted to matching component 155, via mobile device 110 and matching system 150. At this juncture, in an exemplary, non-limiting embodiment, the profile 140 (e.g., which can include photoimage 141) stored at memory 160 can be flagged with an interest flag 172 (shown as bold line) from individual A.

As further illustrated in FIG. 3, matching component 155 can further review the profile 130 (e.g., which can include photoimage 131) to determine if profile 130 (marked with a bold broken line) has been flagged with an interest from individual B. Upon determination of no interest flag 174 (marked with a bold broken line) being associated with photoimage 131, in an embodiment, no further action at that time is made by matching component 155. Profile 140/photoimage 141 can remain flagged 172 as an interest has been expressed by individual A, whereupon a subsequent interest, if ever expressed, in individual A by individual B can be captured.

FIG. 4 illustrates a matching system 400 in accordance with an exemplary, non-limiting embodiment. FIG. 4 is a continuation of the various features presented in FIGS. 1, 2 and 3. As illustrated in FIG. 4, individual B, via local matching component 125 on mobile device 110, can view profile compilation 145. Upon reviewing profile compilation 145 individual B finds the photoimage 131 and/or profile 130 to be of interest. Individual B can place an interest request to matching component 155, e.g., by selecting an ‘interest’ button associated with profile 130 and/or photoimage 131, whereupon local application 125 can generate an interest token 180 which can be transmitted to matching component 155, via mobile device 120 and matching system 150. At this juncture, in an exemplary, non-limiting embodiment, the profile 130 (e.g., which can include photoimage 131) stored at memory 160 can be flagged with an interest flag 176 (shown as bold line) from individual B.

As illustrated in FIG. 4, matching component 155 can further review the profile 140 (e.g., which can include photoimage 141) to determine if profile 140 has been flagged with an interest from individual A. In this exemplary, non-limiting embodiment, a determination can be made that an interest flag 172 (marked with a bold line) is associated with photoimage 141, from individual A. In an embodiment, given the mutual interest between individual A and individual B, the respective profiles are indicated to be mutual interest on respective mobile devices 110 and 120. As mentioned previously, in an exemplary, non-limiting embodiment, the respective profiles are only marked with mutual interest when both individual A and individual B have indicate interest in one another. Until the mutual interest has been determined individual A only sees on mobile device 110 that they have expressed an interest in individual B, but no return (or mutual interest) is indicated from individual B. Similarly, until the mutual interest has been determined individual B only sees on mobile device 120 that they have expressed an interest in individual A, but no return (or mutual interest) is indicated from individual A. Hence, until either both individuals have expressed an interest in each other then all they are aware of is that they have placed an interest, however no match has been made by matching component 155.

Thus, in an exemplary scenario, individual A may see photoimage 141 on their mobile device (e.g., mobile device 110), and may even have seen individual B across the bar, and hence wants to express their interest in individual B by sending request 170. However, individual B is completely unaware of any interest from individual A until individual B also expresses mutual interest by sending request 180. Until the mutual interest is expressed by both individual A and individual B, only matching component 155 is aware of the interest of one individual in another. This exemplary, non-limiting embodiment of operation is counter to conventional systems, where individual A expresses their interest in individual B and a notification (e.g., an email, a website flag, a text message, and the line) of individual A's interest is sent to individual B even if individual has expressed no interest in individual A. A situation with a conventional approach may occur where individual B has never even viewed individual A's profile and/or photoimage, and hence individual B may be oblivious to the existence of individual A until individual B has been informed (e.g., by e-mail notification) of individual A's interest.

In a further exemplary, non-limiting embodiment, individual B may wish to know who was at a particular location that individual B had previously been at. For example, individual B may have been at an event (e.g., a meeting) at a bar and hence was unable to review any profiles (e.g., profile compilations 145) during the evening. However, at a later moment, e.g., upon arriving home, they may wish to see who was at the bar so they can review to see if there was anyone there that they may have had an interest in but were too busy to pursue, via the matching system, at that time. Based upon such a requirement, individual B, while at the bar can make a request for a compilation of profiles (e.g., profile compilations 145) but rather than viewing them directly, individual B can select to store the generated profile compilation for viewing at a subsequent time, e.g., later that evening, the next day, etc. At the subsequent time, individual B can express an interest in an individual's profile (e.g., individual A's profile) in the profile compilation. The interest can be received at the central matching system, and based upon a mutual match occurring, as previously described, a notification can be forwarded to individual A indicating individual B's interest, and a notification can be forwarded to individual B's interest of individual A, where the respective notifications can include respective contact information, etc., as previously described.

In a further exemplary, non-limiting embodiment, individual B may wish to know who expressed an interest in them over some previous period. For example, individual B may have been at an event (e.g., a meeting) at a bar and hence was unable to review any profiles (e.g., profile compilations 145) during the evening. However, at a later moment, e.g., upon arriving home, they may wish to see who expressed an interest and a profile/photoimage (e.g., profile 130/photoimage 131) can be displayed on their device (e.g., mobile device 120) via the local application (e.g., local matching component 125). Thus, for a pre-defined period of time (which can be configured via local matching component 125) individual B can view profiles of interested individuals. Upon expiration of the pre-defined period of time (e.g., 1 hour later, the next day, 24 hours later, a week later, never, etc.), presentation of the profiles of interested individuals can be terminated.

Also, the mutual matching operation, as previously described, can, in another exemplary embodiment, be based on interests of individuals A and B. For example, individual A can configure their matching application to only show profiles (e.g., in profile compilation 135) of people that have a particular interest(s), e.g., reading, theatre, sports, non-smoker, individuals with no pets, individuals that have no children, individuals of a particular physical trait such as a given height, physique, hair color, etc., individuals in a given salary/wealth range, etc. Hence, for example, in the event of individual A configuring their show profile criteria to be ‘non-smokers only’, and if individual B is a smoker, then individual B's profile would not be presented (e.g., profile compilation 135 would not include photoimage 141).

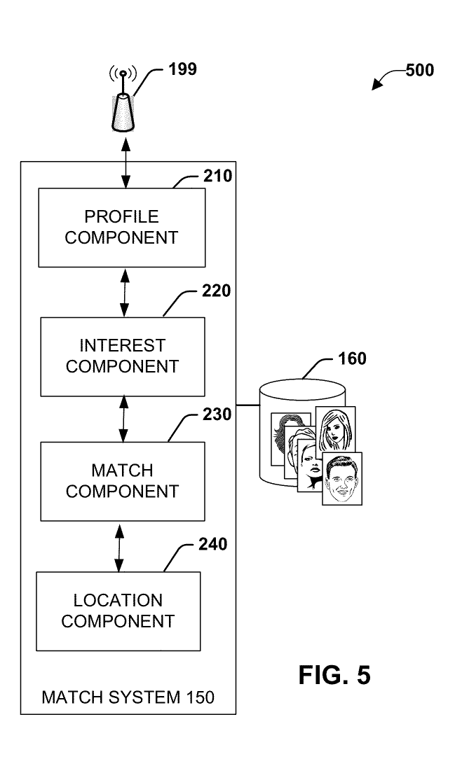

An exemplary, non-limiting embodiment is shown in FIG. 5 of the matching system 150, which can comprise any of a profile component 210, an interest component 220, and match component 230. A storage device 160 can be associated with matching system 150, where storage device 160 can store any information as required to facilitate operation of the match system 150, including any profiles (e.g., profiles 130 and 140) and photoimages (e.g., photoimages 131 and 141) associated with individuals (e.g., individuals A and B) utilizing the mutual matching application. Profile component 210 can provision any operations and features as required to facilitate operation of the match system 150. Profile component 210 can receive profiles and photoimages, where the profiles and photoimages have been configured on a remote device (e.g., mobile device 110 and/or 120). Profile component 210 can store received profiles, etc., on storage device 160. Profile component 210 can further, in response to a request for profiles (e.g., request 132 or 142), identify a location of the device generating the profile request (e.g., mobile device 110 or 120). Based on the determined location, the profile component 210 can review the profiles in storage device 160 which have been activated (e.g., a profile request 132 or 142, has been received for an individual's profile). Based on the determined location, and activated profiles, a profile compilation (e.g., profile compilation 135 or 145) can be generated by profile component 210, whereupon the profile compilation can be transmitted (e.g., via transceiver 199).

Interest component 220 can be utilized to determine a mutual interest between two or more individuals. For example, individual A has expressed an interest in individual B (e.g., by submitting interest token 170) and individual B has expressed an interest in individual A (e.g., by submitting interest token 180). Interest component 220 can query storage device 160, and review profiles 165 to determine whether a mutual interest has been flagged. For example, upon receipt of interest token 180 indicating interest by individual B in individual A, has individual A already expressed on interest in individual B (i.e., interest token 170 has already been generated and hence, profile 140/photoimage 141 is flagged 172).

Match component 230 can, based on an indication of mutual matching from interest component 220, forward an indication to individual A that individual B has expressed an interest and further can forward an indication to individual B that individual A has expressed an interest. As mentioned previously, at this juncture individuals A and B are informed of the mutual interest, while prior to the mutual match being determined, neither individual is aware of the interest in themselves by the other individual.

Location component 240 can, based on the mutual match being established, can be used to direct individual A to individual B. In an aspect, while the mutual match is being established, a situation may occur where one of and/or both individual A and individual B can see each other, and possibly, the photoimages 131 and 141 are used to establish the interest further based on visual attraction. In another situation, individuals A and B have not established visual connection and hence location component 240 can be utilized to provide a direction indicator for presentment on the respective mobile devices 110 and 120. The location of the other individual can be forwarded to the individual's phone from the location component 240, and respective local matching component 115 or 125 can be utilized to present the direction indicator to facilitate a meeting between individual A and B. An exemplary situation is a crowded nightclub where individuals A and B have yet to meet across the crowded location.

In another exemplary, non-limiting embodiment, match component 230 can forward respective profiles 130 and 140 which can include a phone number or similar communication means to facilitate communication between individual A and individual B upon the mutual match being established. In an alternative exemplary, non-limiting embodiment, communication component 250 can be utilized to provide communication for individual A and individual B. Hence, in a situation where individuals A and B have yet to physically meet, or prefer to conduct initial communications via a text message, telephone conversation, and the like, communication component 250 can provide a secure means for communication whereby text messages, email communications, telephone conversation, etc., are conducted by a proxy email address, telephone number, and the like. Hence, while a mutual interest has been established, neither individual is providing their own personal email, telephone number, etc., during initial communications. At some subsequent juncture, individuals A and B can provide their own personal contact information as they deem fit. However, until that subsequent juncture, communication component 230 can generate proxy email addresses, telephone numbers, etc., which can be forwarded for presentment via respective local matching components 115 and 125 on respective mobile devices 110 and 120.

It is to be appreciated that in a situation where mobile devices 110 and 120 are within a certain communication range, any suitable means for communication can be invoked, e.g., where devices are within BLUETOOTH communication range, communications can be conducted via BLUETOOTH.

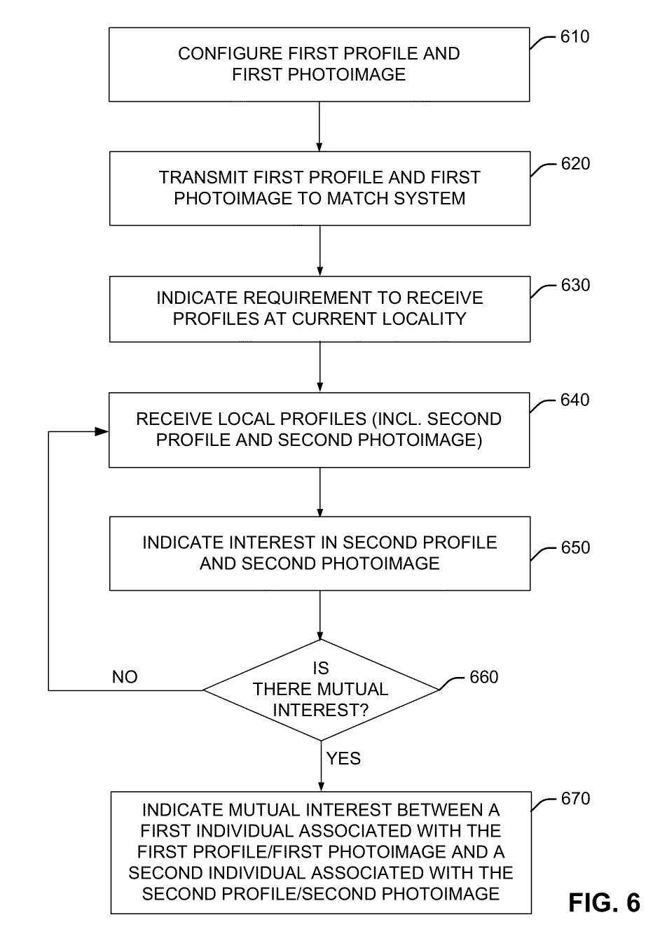

FIGS. 6-9 illustrate exemplary methodologies relating to identifying a mutual match between individuals. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement the methodologies described herein.

FIG. 6 illustrates a methodology 600 to facilitate generation of mutual matching between individuals, according to an exemplary, non-limiting embodiment. At 610 an individual (e.g., individual A) configures a first photoimage (e.g., photoimage 131) and if desired, further information comprising a first profile. It is to be appreciated that the first profile can simply contain a first photoimage (and a name identifier, if needed, where the name identifier can be individuals A's name, or a pseudonym) or the first profile can further contain information regarding individual A's physique, interests, personal history, etc. The first photoimage and first profile can be entered via a matching component operating locally on a device, where the device can be a mobile phone, a laptop computer, a tablet personal computer, a personal computer, or any other suitable means for entering and transmitting information. Information and responses can be entered on the device via an interactive display, keyboard and the like available on the device.

At 620, the first photoimage and the first profile are forwarded from the device to a central matching system for storage, e.g., storage in a data store or similar memory component, along with any other profiles received from other individuals utilizing the mutual matching system.

It is to be appreciated that for the sake of brevity of description, while not shown, a second individual, individual B, can also configure a second profile which can include a second photoimage on a device (e.g., a mobile phone or other computing device as previously described) and forward the second profile and second photoimage to the central matching system for storage.

At 630, individual A (or individual B) can request, via the device, a profile compilation be generated be forwarded to them where the profile compilation includes any individuals in the vicinity of the location of individual A, where the location of individual A and the other individuals in locality can be determined by GPS, etc. As previously mentioned, individual A may have entered a location, such as a bar, and wishes to view photoimages/profiles of any other individuals partaking in the mutual match application.

At 640, individual A receives on the device the profile compilation, where the profile compilation can include a photoimage/profile generated by individual B. As mentioned previously, the profile compilation can be generated dynamically by the central system and hence an updated profile compilation can be forwarded to individual A's device for presentment to individual A (e.g., via a display on the device), upon determination, by the central system, that individual B is in vicinity of individual A. Determination of the location of individual B can be performed in conjunction with location information (e.g., GPS, cellular triangulation by location measurement units (LMUs) associated with cellular systems, and the like) being generated by a device associated with individual B, individual B placing a profile compilation request, and the like. Further, individual A and/or individual B may not have full locating capabilities, e.g., the current location is not best situated for accurate GPS operations to be performed (e.g., location is in a building, location is in a built up area affecting the line-of-sight of location systems) and hence individual A and/or B can, via a matching component on their respective device, enter their current location either by typing in the address, in conjunction with a mapping application operating on the device, and the like.

At 650, individual A can indicate, e.g., via a matching component operating on their device, their interest in the photoimage/profile associated with individual B. As part of indicating their interest, and an interest token (or similar notification) can be generated at their device and forwarded to the central matching system. Upon receipt of the interest token at the central matching system, the stored photoimage and profile of individual B can be flagged as having an interest expressed thereof by individual A. For example, the central matching system can flag the photoimage/profile associated with individual B as having an interest expressed by individual A.

At 660, a determination can be made as to whether there is a mutual interest being expressed by both individual A and individual B. For example, after individual A expressed an interest in individual B, individual B, upon viewing a respective profile compilation presented on their associated device expressed an interest in individual A. An interest token was forwarded from the device of individual B to the central matching system and individual A's photoimage/profile is flagged as having an interest from individual B. As shown with reference to FIGS. 3 and 4, if individual B has not expressed an interest in individual A then only individual B's photoimage/profile is flagged with interest. In such a situation the flow can return to 640 for further profile compilations to be received/presented. It is to be appreciated that the interest in individual B by individual A remains flagged until a predefined duration, or other event such as individual A or individual B no longer being in vicinity thereof, e.g., either or both individual A and individual B have left the bar in the previously presented example.

However, if there is mutual interest (e.g., photoimage/profile of individual A and photoimage/profile of individual B have been flagged as mutually interested, and respective flags are associated with the photoimage/profile of individual A and photoimage/profile of individual B) then the respective photoimages/profiles can be forwarded to both individuals indicating that there is a mutual interest being expressed. For example, where individual A has expressed an interest in individual B, the photoimage of individual B can be displayed with an ‘interested’ flag on the device associated with individual A, as well as any profile information that individual B wishes to be made available to individual A. Similarly, where individual B has also expressed an interest in individual A, (e.g., by forwarding an interest token/notification) the photoimage of individual A can be displayed with an ‘interested’ flag on the device associated with individual B as well as any profile information that individual A wishes to be made available to individual B. Based on the mutual matching individual A can approach individual B (and vice-versa), or other means of communication can be initiated such as text messaging ability, telephone, email, etc., where the communication can be with the personal telephone number, email address, etc., associated with the individual or can be via a proxy telephone number, email address, etc., to maintain a level of privacy/confidentiality between individual A and individual B and the matching system.

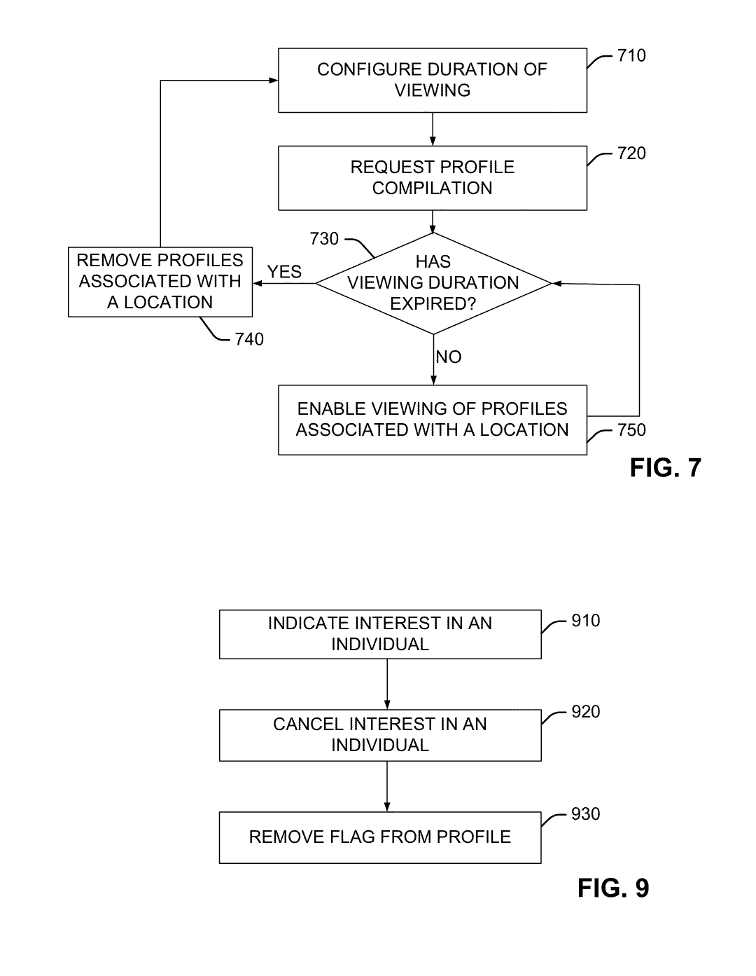

FIG. 7 illustrates a methodology 700 to facilitate viewing of a compilation of profiles, according to an exemplary, non-limiting embodiment. At 710, as previously described an individual (e.g., individual B) may wish to know who was at a particular location that individual B had previously been at. For example, individual B may have been at a particular location, e.g., a restaurant, for a business dinner, but owing to the formal occasion was unable to review any profiles of fellow diners during the evening. However, individual B may wish to view a compilation of profiles at a subsequent time. Accordingly, individual B can configure a profile viewing duration, whereby the viewing duration relates to how long a particular profile compilation is viewable. In an embodiment, the viewing duration can be stored locally on whichever device individual B is communicating with a central matching server, while in another embodiment, the viewing duration can be forwarded for storage (e.g., by a data storage device) at the central matching server.

At 720, while individual B is at the location of interest, e.g., the restaurant, individual B can indicate that they are at the location of interest and generate a request for a profile compilation to be generated and forwarded to individual B. As previously described, in an embodiment, the profile compilation can include a profile for any other subscribers of the mutual matching system that have indicated they are also at the restaurant, or in the vicinity thereof. In an embodiment, the profile compilation can be forwarded from the central system to the device being utilized by individual B. In another embodiment, the profile compilation can be stored at the central system (e.g., by a data storage device) enabling downloading and viewing of the profile compilation at a subsequent time on the device or other computer system. For example, by retaining a copy of the generated profile compilation on the central system the profile compilation can be viewed on the device being utilized by individual B to request the profile compilation or viewed on another computing device such as a desktop computer located at the residence of individual B.

At 730, a determination can be made regarding whether the profile viewing duration, configured at 710, has expired. In the event of the profile viewing duration expiring, the methodology flows to 740 whereupon the profile compilation can be removed, e.g., deleted, from whichever device(s) may have the profile compilation stored thereon. For example, upon expiration of the profile viewing duration, the profile compilation can be removed from any of the central system, the device from which the profile compilation was requested, the desktop computer, etc.

Alternatively, at 730, upon determining that the profile viewing duration has not expired, viewing of the profile compilation is enabled at 750. As previously mentioned, viewing of the profile compilation can be performed on any suitable device, and if individual B finds a profile of interest (e.g., individual A's profile), a notification can be sent to the central system indicating the interest of individual B in the profile of individual A, whereupon the mutual matching operation can be performed to determine a reciprocal interest in individual B by individual A, notifications sent regarding the mutual interest, etc. The flow returns to 730 where further determination can be performed regarding whether the viewing duration has expired. It is to be appreciated that while a viewing duration may not have expired individual B can delete the profile compilation from whichever device(s) it stored upon at any time.

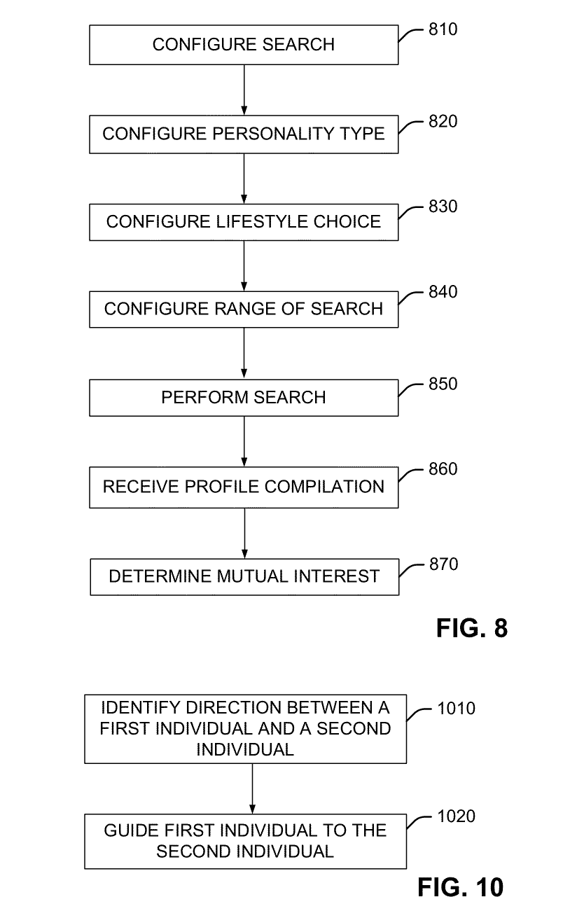

FIG. 8 illustrates a methodology 800 to facilitate configuration of a profile search. At 810, a search can be configured based on one or more interests or requirements of an individual. When a request for a profile compilation is generated (e.g., at a mobile device), depending upon the number of other subscribers in the locality of the individual generating the request, a corresponding number of profiles can be presented as part of the profile compilation compiled and forwarded from a central system. However, rather than receiving a plethora of profiles at the requesting device, the individual (e.g., individual A) can configure their profile compilation request such that the request initiates filtering of the profile compilation. For example, stored as part of the individual's profile (e.g., at a data store associated with the central system) can be one or more filtering parameters such that when a profile compilation operation is performed for the individual, any individuals who's profile does not match one or more requirements of the individual can be removed from the profile compilation during compilation by the central system. Alternatively, the filtering parameters can be stored locally (e.g., on the mobile device) whereby all of the available profiles in the profile compilation are forwarded to the mobile device and filtering is performed at the mobile device. The option of local filtering enables the operator of the device (e.g., individual A) to set different filtering parameters and review which profiles fit the different filtering parameter settings. For example, one set of filtering parameters can be set to non-smoker, likes theatre, does not like sporting events, another set of filtering parameters can be set to non-smoker and likes theatre only, whereby the individual is willing to consider other individuals who also like sporting events.

Accordingly, at 820, filtering parameters relating to personality type can be configured such as height, hair color, ethnicity, etc., can be accordingly set.

At 830, lifestyle filtering parameters can also be set, where such parameters can include sporting activities, pastimes, hobbies, interests, smoker, non-smoker, etc. It is to be appreciated that any filtering parameters can be entered or configured and are not limited to those presented at 820 or 830, or as elsewhere described herein.

At 840, a search range can be configured. As previously mentioned, generation of a profile compilation can be based on a location of an individual interested in seeing what other subscribers are in their vicinity. In an embodiment, the search range for individuals can be highly localized, e.g., configured so that only individuals in a particular location, e.g., a bar, are shown in the profile compilation. In another embodiment, the search range for individuals can be extended to cover an entire street for example, whereby the street may comprise of a plurality of locations, e.g., the street has a number of bars located thereon. By extending the range to cover the street, an individual (e.g., individual B) does not have to be proximate to the current location of another individual (e.g., individual A), for example individual B is in a bar 4 doors down the street to the bar that individual A is currently located at. Hence, when individual A requests a profile compilation to be performed, even though individual B is possibly not in visual range of individual A at the time of the generation of the profile compilation, the profile/photoimage for individual B can be included in the profile compilation. The range setting can be a simple distance setting whereby the various individuals in an area swept by the distance setting (e.g., the distance setting acting as a radius of a swept circle) can be identified and their profiles are incorporated into a profile compilation. In another aspect, the range setting can be a particular location. For example, individual A is at a first bar location but is wondering who might be at a second bar location. By entering an address of the second bar as the range parameter a profile compilation can be generated indicating which individuals are at the second bar, whereupon, individual A can go to the second bar, or not, based on what profiles they are seeing in the compiled profile compilation.

At 850, a search can be performed based on the various parameters, settings, configured at 810-840.

At 860, based on the various parameters, settings, etc., configured at 810-840 a profile compilation can be received, e.g., at the mobile device of individual A.

At 870, as previously described, at mutual matching operation can be performed based upon reciprocal interest between individual A and another individual (e.g., individual B).

FIG. 9 illustrates a methodology 900 to facilitate cancelling of an interest in an individual. At 910, as described herein, an individual (e.g., individual A) can indicate an interest in another individual (e.g., individual B) in response to receiving a profile compilation. Individual A, via their mobile device, can indicate an interest in individual B whereby a profile/photoimage associated with individual B can be flagged (e.g., at the data store of the central system) with an interest expressed by individual A.

However, at a subsequent time individual A may no longer be interested in individual B. For example, if individual B is within visible range of individual A and individual A sees individual B doing something that individual A doesn't like, individual A may want to remove their interest in individual B. Accordingly, at 920, on the mobile device being operated by individual A, an option (e.g., a button) can be presented of the nature of “Remove Interest” by the profile of individual B displayed on individual A's mobile device.

At 930, upon receipt of the request to remove interest at the central system, the interest flag on individual B's profile indicating an interest being expressed by individual A can be removed. Accordingly, even in the event of individual B subsequently indicating an interest in individual A, no matching will be performed as there is no longer a flag on individual B's profile indicating an interest of individual A.

FIG. 10 illustrates a methodology 1000 to facilitate directing individuals towards each other to meet. At 1010, as previously described, a first individual (e.g., individual A) while having been mutually matched with a second individual (e.g., individual B), individuals A and B may not be physically visible to each other (e.g., individuals A and B are in a crowded bar, at a sports arena, at a nightclub, etc.). Hence, to facilitate a meeting between individuals A and B the respective locations of individuals A and B can be determined, for example based on GPS signaling received from their respective mobile devices. Based on their respective locations a direction(s) can be identified to facilitate their meeting.

At 1020, based on the identified direction(s), a mapping application on the respective mobile devices can be operable to guide individuals A and B to meet at a physical location.

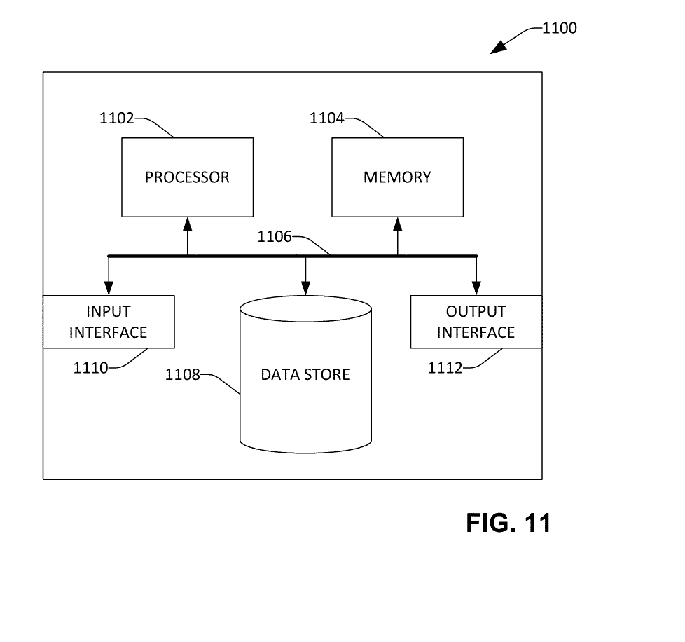

Referring now to FIG. 11, a high-level illustration of an exemplary computing device 1100 that can be used in accordance with the systems and methodologies disclosed herein is illustrated. For instance, the computing device 1100 may be used in a system to facilitate a mutual match operation to be performed, e.g., in a system comprising two individuals using mobile devices (e.g., respective mobile devices such as cellular phones) in conjunction with a centralized system co-ordinating the mutual matching operation(s) as described herein. The computing device 1100 includes at least one processor 1102 that executes instructions that are stored in a memory 1104. The instructions may be, for instance, instructions for implementing functionality described as being carried out by one or more components discussed above or instructions for implementing one or more of the methods described above. The processor 1102 may access the memory 1104 by way of a system bus 1106. In addition to storing executable instructions, the memory 1104 may also store operating parameters, required operating parameters, and so forth.

The computing device 1100 additionally includes a data store 1108 that is accessible by the processor 1102 by way of the system bus 1106. The data store 1108 may include executable instructions, operating parameters, required operating parameters, etc. The computing device 1100 also includes an input interface 1110 that allows external devices to communicate with the computing device 1100. For instance, the input interface 810 may be used to receive instructions from an external computer device, from a user, etc. The computing device 1100 also includes an output interface 1112 that interfaces the computing device 1100 with one or more external devices. For example, the computing device 1100 may display text, images, etc., by way of the output interface 1112.

Additionally, while illustrated as a single system, it is to be understood that the computing device 1100 may be a distributed system. Thus, for instance, several devices may be in communication by way of a network connection and may collectively perform tasks described as being performed by the computing device 1100.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

One of ordinary skill in the art can appreciate that the various embodiments of presented herein relating to mutual matching described herein can be implemented in connection with any computer or other client or server device, which can be deployed as part of a computer network or in a distributed computing environment, and can be connected to any kind of data store. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in video viewing and tagging mechanisms as described for various embodiments of the subject disclosure.

As mentioned above, while exemplary embodiments have been described in connection with various computing devices and network architectures, the underlying concepts may be applied to any network system and any computing device or system in which it is desirable to implement mutual matching.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component”, “module”, “system”, and the like, are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned exemplary embodiments have been described with respect to interaction between several components. It can be appreciated that such components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies previously described.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the various embodiments presented herein are not limited to any single embodiment, but rather is to be construed in with according breadth, spirit and scope.

What is claimed is:

1. A method, comprising:
receiving a first profile relating to a first individual;
receiving a second profile relating to a second individual;
receiving a first notification associated with the first individual, wherein the first notification indicating the first individual having an interest in the second individual;
determining whether a second notification already being received from the second individual, wherein the second notification indicating the second individual having an interest in the first individual; and
in the event of determining the second notification being received, matching the first individual with the second individual.

2. The method of claim 1, further comprising:
in response to the determining of a second notification being received, notifying the first individual and the second individual of a mutual match.

3. The method of claim 1, further comprising:
in the event of determining the second notification is still to be received, tagging the second profile, wherein the tag indicating an interest being expressed by the first individual.

4. The method of claim 1, wherein the first profile including a photoimage of the first individual and the second profile including a photoimage of the second individual.

5. The method of claim 1, further comprising receiving a geographic locator, the geographic locator relating to a geographic location of the first individual.

6. The method of claim 5, further comprising identifying a profile associated with an individual located in a vicinity of the first individual.

7. The method of claim 6, further comprising forwarding the identified profile to the first individual.

8. The method of claim 5, further comprising receiving a distance indicator identifying a distance from the geographic location the first individual wants to receive profiles from individuals in an area swept by this distance.

9. The method of claim 1, further comprising receiving a time indicator indicating a time duration enabling the first individual viewing of any profiles associated with individuals being located at a particular location visited by the first individual.

10. The method of claim 9, wherein the viewing being performed by first individual subsequent to the first individual leaving the particular location.

11. The method of claim 1, wherein the first notification being received from a mobile computing device.

12. A system, comprising:
a profile component configured to:
receive a first indication of a first individual having an interest in a second profile associated with a second individual, and
receive a second indication of the second individual having an interest in a first profile associated with the first individual;
an interest component configured to determine the existence of the first indication and the second indication and, based on the determined existence, identify mutual interest between the first individual and the second individual; and
a match component configured to forward the first indication to the second individual and the second indication to the first individual.

13. The system of claim 12, wherein the first profile comprises a first digital image of the first individual and the second profile comprises a second digital image of the second individual.

14. The system of claim 12, wherein at least one of the first indication or the second indication are received from a mobile computing device, wherein the mobile device communicatively coupled to the system via wireless communication.

15. The system of claim 12, wherein the profile component is further configured to:
receive a request from a mobile device associated with the first individual, wherein the request includes a geographic location indicator indicating a location of the mobile device;
determine any other individuals located in a vicinity of the first individual;
generate a profile compilation, wherein the profile compilation comprises at least one individual located in the vicinity of the first individual; and
forward the profile compilation to the mobile device.

16. The system of claim 15, wherein the interest component is further configured to receive a time indicator, the time indicator identifies a time duration during which the profile compilation is available for viewing at the mobile device.

17. The system of claim 12, further comprising a memory component configured to store the first profile and the second profile.

18. A computer readable storage medium comprising computer executable instructions that, in response to execution, cause a computing system including a processor to perform operations, comprising:
receiving a first profile relating to a first individual;
receiving a second profile relating to a second individual;
receiving a first notification associated with the first individual, wherein the first notification indicating the first individual having an interest in the second individual;
determining whether a second notification already being received from the second individual, wherein the second notification indicating the second individual having an interest in the first individual; and
in the event of determining the second notification being received, matching the first individual with the second individual.

19. The computer readable storage medium of claim 18, wherein the operations further comprising:
notifying, in response to the determining of a second notification being received, the first individual and the second individual of a mutual match.

20. The computer readable storage medium of claim 18, wherein the operations further comprising:
in response to the determining of a second notification being received, indicating to the second individual a location of the first individual.
